(19) United States
(12) Patent Application Publication
(10) Pub. No.: US 2026/0039931 A1
(43) Pub. Date: Feb. 5, 2026

(54) SYSTEMS AND METHODS FOR GENERATING MEMBERSHIP-RELATED CONTENT FOR A CHANNEL USING ARTIFICIAL INTELLIGENCE

(71) Applicant: Google LLC, Mountain View, CA (US)

(72) Inventors: Dhruv Bakshi, Zug (CH); Silviu Bota, Horgen (CH)

(21) Appl. No.: 19/287,280

(22) Filed: Jul. 31, 2025

Related U.S. Application Data
(60) Provisional application No. 63/677,836, filed on Jul. 31, 2024.

(51) Int. Cl. H04N 21/85; H04N 21/24

(52) U.S. Cl. CPC H04N 21/85; H04N 21/2407

(57) ABSTRACT

A method includes detecting, by a processing device of a content sharing platform, a trigger event associated with a channel of the content sharing platform. In response to the trigger event, content is automatically generated for a plurality of channel members associated with the channel. Automatically generating the content for the plurality of channel members comprises determining a type of content associated with the trigger event, generating a prompt based on the trigger event and the type of content, and determining, using an artificial intelligence (AI) model and the generated prompt, the content for the plurality of channel members associated with the channel. An operation is performed using the generated content.

### RELATED APPLICATION

This application claims the benefit of U.S. Provisional Application No. 63/677,836, filed Jul. 31, 2024, the entire content of which is hereby incorporated by reference.

### TECHNICAL FIELD

The disclosed implementations relate to methods and systems for generating membership-related content for a channel using artificial intelligence.

### BACKGROUND

Content sharing platforms allow users to connect to and share information with each other. Many content sharing platforms include a content sharing aspect that allows users to upload, view, and share content, such as video items, image items, audio items, and so on. Other users of the content sharing platform can comment on the shared content, discover new content, locate updates, share content, and otherwise interact with the provided content. The shared content can include content from professional channel owners, e.g., movie clips, TV clips, and music video items, as well as content from amateur channel owners, e.g., video blogging and short original video items.

### SUMMARY

The following presents a simplified summary of various aspects of this disclosure in order to provide a basic understanding of such aspects. This summary is not an extensive overview of all contemplated aspects, and is intended to neither identify key or critical elements nor delineate the scope of such aspects. Its purpose is to present some concepts of this disclosure in a simplified form as a prelude to the more detailed description that is presented later.

An aspect of the disclosure provides a computer-implemented method which includes detecting, by a processing device of a content sharing platform, a trigger event associated with a channel of the content sharing platform. In response to the trigger event, content is automatically generated for a plurality of channel members associated with the channel. Automatically generating the content for the plurality of channel members comprises determining a type of content associated with the trigger event, generating a prompt based on the trigger event and the type of content, and determining, using an artificial intelligence (AI) model and the generated prompt, the content for the plurality of channel members associated with the channel. An operation is performed using the generated content.

A further aspect of the disclosure provides a system comprising: a memory; and a processing device, coupled to the memory, the processing device to perform a method according to any aspect or implementation described herein.

A further aspect of the disclosure provides a non-transitory computer-readable medium comprising instructions that, responsive to execution by a processing device, cause the processing device to perform operations according to any aspect or implementation described herein.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example of system architecture, in accordance with implementations of the disclosure.

FIG. 2 is an example graphical user interface (GUI) showing an example auto-generated post, in accordance with implementations of the present disclosure.

FIG. 3 depicts a flow diagram of an example method 300 for generating membership related content, in accordance with implementations of the present disclosure.

FIG. 4 depicts a block diagram of an example computing device operating in accordance with one or more aspects of the present disclosure.

### DETAILED DESCRIPTION

The content served by content sharing platforms can include video content, image content, audio content, text content, and so on (which may be collectively referred to as “media items”). Such media items can include audio clips, movie clips, TV clips, and music videos, as well as amateur content such as video blogging, short original videos, pictures, photos, other multimedia content, etc. In some content sharing platforms, channel owners can provide their content to other users via one or more personal channels (“channel”). A channel can be data content available from a common source or data content having a common topic, theme, or substance. The channel can be associated with a homepage for the channel owner's account and include media items having a common topic, theme, or substance. The media items can be chosen, made available, and/or uploaded by the channel owner to the channel. The channel owner can further customize their channel(s) by selecting a background and color scheme, controlling some of the information that visually represents the channel, etc.

Channel owners can enable certain content-related features to monetize their channel(s). For example, content creators can realize earnings from advertisements (“ads”) that would appear during certain segments of certain media items, receive revenue from viewers via a gratuity feature, sell merchandise, etc. In some instances, channel owners can generate revenue by enabling channel memberships that offer viewers (e.g., users of the content sharing platform) one or more particular tiers of content access (referred to as a “membership tier”). A membership tier can represent a feature of the content sharing platform that allows “members” to join a channel through monthly fees and receive members-only benefits also referred to as privileges. Each membership tier can have different privileges such as access to exclusive content (e.g., videos and channel owner posts not made available to non-members), badges, emojis, access to live-streams, comments, chats and other bonus content that only members can access. A post can be content that is shared with viewers (e.g., members), such as, for example, text (e.g., a story), an image, a video, a poll, a quiz, etc. In certain instances, a particular channel can include multiple membership tiers, where each tier (or level) can include different privileges for a different monthly fee.

Channel owners who post exclusive content (membership-only content) typically increase member contentment, thereby increasing member growth and retention rates. However, for certain channel owners, generating and submitting (e.g., posting) exclusive content, such as posts and videos that only members can view, can be a difficult and time-consuming task. Failure to produce adequate exclusive content can lead to loss of the respective members, thus causing the channel owners and the content sharing platform to miss out on potential revenue. Further, in many instances, the channel owner may have to review their already posted videos and other content to aid in their production of the exclusive content, thus causing the channel owner to waste considerable time and computing resources.

Aspects and implementations of the present disclosure address the above and other deficiencies by providing a system for generating content using artificial intelligence. In particular, the system of the present disclosure can automatically generate one or more posts for a channel and/or one or more videos (or video clips) for the channel. A generated post can be a video related post (a post describing a recently uploaded video, such as a video summary), a commemoration post (a post describing certain member-related observances, such as a member anniversary since joining the channel or thanking a new member), a milestone post (a post describing certain channel-related milestones, such as the channel gaining a certain amount of members), a launch post (a post indicating to viewers that the channel enabled channel memberships), etc. The post can be automatically submitted (e.g., posted) to the channel or provided to the channel owner for review. During review, the channel owner can submit the post as generated or edit the post prior to submitting.

A generated video can be a summary video (a video clip with highlights from one or more other videos on the channel, such as from a recent live-streamed video), a behind the scenes video (a video generated from unposted footage), a commemoration video (a video reflecting certain member-related observances, such as a member anniversary since joining the channel or thanking a new member), etc. The videos can be automatically submitted (e.g., uploaded) to the channel or provided to the channel owner for review. During review, the channel owner can submit the video as generated or edit the video prior to submitting. In some implementations, the channel owner can submit the automatically generated content items for view by each member of the channel or for view by only certain membership tiers of the channel.

The system of the present disclosure can use one or more artificial intelligence models, such as a large language model (LLM) to generate the (exclusive) content items (e.g., members-only posts and/or videos) for one or more membership tiers. A LLM is designed to understand and generate human-like text by analyzing and processing vast datasets of language from books, articles, and the internet. To obtain the content items, the present system can generate a set of input prompts for the LLM. Each input prompt can contain instructions for the LLM and serve to guide the output of the LLM. In particular, the input prompt can include context about channel memberships, the task assigned to the LLM (e.g., the type of data or analysis desired from the LLM), the data format in which to generate the output, related video data, related audio data (e.g., audio transcription data), channel metadata, etc. The present system can then instruct the LLM to complete the assigned task (e.g., generate a particular type of posts and/or videos) and generate output data reflecting the results. Using the output data obtained from the LLM, the present system can, based on certain preferences, automatically pre-fill a post window, automatically submit a post, automatically upload a video, present generated content for review, etc.

Aspects of the present disclosure result in improved performance of channel membership tools. In particular, the aspects of the present disclosure enable generating content items for channel owners. As a result, the channel owner is able to conserve time and computing resources related to submitting content items to their channel, rather than expending time and computing resources by manually preparing content. Further, by automatically generating and submitting the content items, the retention rate for members can be improved.

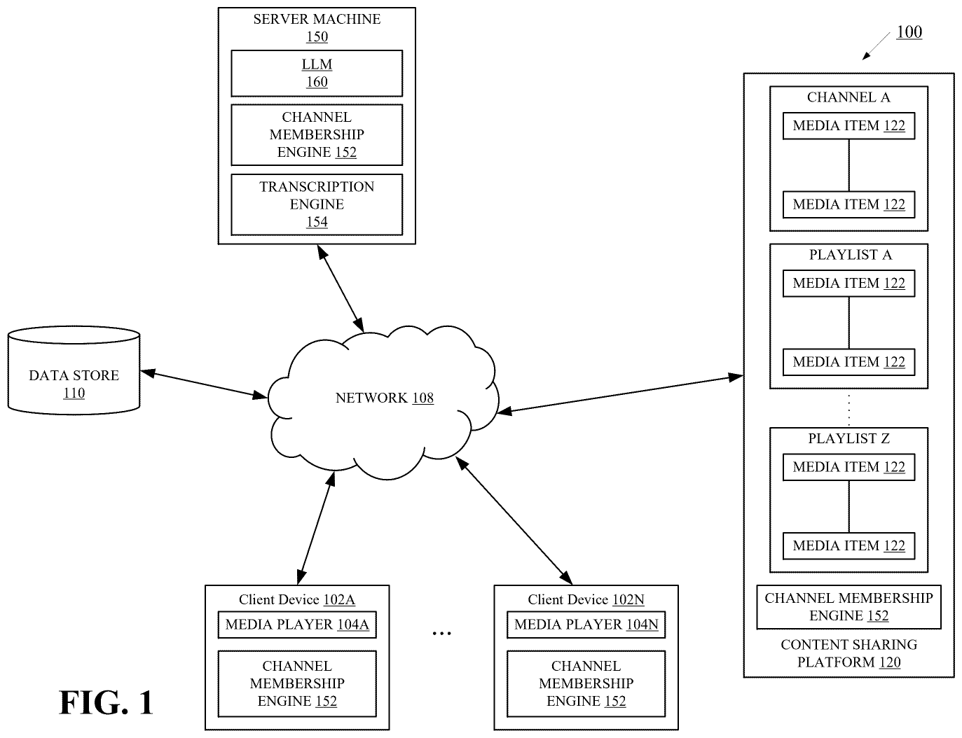

FIG. 1 illustrates an example system architecture 100, in accordance with implementations of the present disclosure. The system architecture 100 (also referred to as “system” herein) includes client devices 102A-102N, data store 110, content sharing platform 120, and/or server machine 150 each connected to a network 108. In some implementations, network 108 can include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, data store 110 is a persistent storage that is capable of storing data as well as data structures to tag, organize, and index the data. Data store 110 can be hosted by one or more storage devices, such as main memory, magnetic or optical storage-based disks, tapes or hard drives, NAS, SAN, and so forth. In some implementations, data store 110 can be a network-attached file server, while in other implementations data store 110 can be some other type of persistent storage such as an object-oriented database, a relational database, and so forth, that may be hosted by application server 120 or one or more different machines (e.g., server machine 150, client device 102A-102N) coupled to the platform 120 via network 108.

Client devices 102A-102N can each include computing devices such as personal computers (PCs), laptops, mobile phones, smart phones, tablet computers, netbook computers, network-connected televisions, etc. In some implementations, client devices 102A-102N can also be referred to as “user devices.” In some implementations, each client device 102A-102N can include a media player 104A-104N. In some implementations, media player 104A-104N can be applications that allow users, such as channel owners, viewers, etc. to play back, view, or upload content, such as images, video items, web pages, documents, audio items, etc. For example, media players 104A-104N can be a web browser that can access, retrieve, present, or navigate content (e.g., web pages such as Hyper Text Markup Language (HTML) pages, digital media items, etc.) served by a web server. Media player 104A-104N can render, display, or present the content (e.g., a web page, a media viewer) to a user. In some implementations, media player 104A-104N can provide a user interface for presenting the media items and/or enabling user interaction with the media player 104A-104N. Media player 104A-104N can also include an embedded media player (e.g., a Flash® player or an HTML5 player) that is embedded in a web page (e.g., a web page that can provide information about a product sold by an online merchant). In another example, media players 104A-104N can be a standalone application (e.g., a mobile application, or native application) that allows users to playback digital media items (e.g., digital video items, digital images, electronic books, etc.). According to aspects of the present disclosure, media players 104A-104N can be a content sharing platform application for users to record, edit, and/or upload content for sharing on the content sharing platform. As such, media players 104A-104N can be provided to client devices 102A-102N by content sharing platform 120. For example, media players 104A-104N can be embedded media players that are embedded in web pages provided by the content sharing platform 120. In another example, media players 104A-104N can be applications that are downloaded from content sharing platform 120. In some implementations, the applications can include channel membership engine 152 and/or transcription engine 154.

In some implementations, content sharing platform 120 and server machine 150, can be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, or hardware components that can be used to provide a user with access to media items or provide the media items to the user. Content sharing platform 120 can allow a user to consume, upload, search for, approve of (“like”), disapprove of (“dislike”), or comment on media items. Content sharing platform 120 can also include a website (e.g., a webpage) or application back-end software that can be used to provide a user with access to the media items.

In some implementations of the disclosure, a “user” can be represented as a single individual. However, other implementations of the disclosure encompass a “user” being an entity controlled by a set of users and/or an automated source. For example, a set of individual users federated as a community in a social network can be considered a “user”. In another example, an automated consumer can be an automated ingestion pipeline, such as a topic channel, of the content sharing platform 120. In some implementations, the user can access content on sharing platform 120 through a user account. The user can access (e.g., log in to) the user account by providing user account information (e.g., username and password) via an application on client device 110 (e.g., media player 104A-104N). In some implementations, the user account can be associated with a single user. In other implementations, the user account can be a shared account (e.g., family account shared by multiple users) (also referred to as “shared user account” herein). The shared account can have multiple user profiles, each associated with a different user. The multiple users can login to the shared account using the same account information or different account information. In some implementations, the multiple users of the shared account can be differentiated based on the different user profiles of the shared account.

In some implementations, an authorizing data service (also referred to as a “core data service” or “authorizing data source” herein) is a secure service that has access to data pertaining to user accounts on the content sharing platform 120 and that can use this data to decide whether to authorize a user account to obtain a requested content. In some implementations, the authorizing data service can authorize a user account (e.g., a client device associated with the user account) to access the requested content, authorize delivery of the requested content to the client device, or both. Authorization of the delivery of the content can involve authorizing how the content is delivered. In some implementations, the authorizing data service can use user account information to authorize the user account. In some implementations, an authentication token associated with client device 102A-102N or media player 104A-104N can be used to determine whether to authorize the user account and/or playback of requested content. In some implementations, the authorizing data service is part of content sharing platform 120. In other implementations, the authorizing data service can be an external service, such as a highly-secured authorizing service offered by a third-party.

In some implementations, content delivery platform 120 can use a content distribution network (CDN) (not shown) to stream the media items to one or more client devices 102A-102N for consumption by users. A CDN includes a geographically distributed network of servers that work together to provide fast delivery of content. The network of the servers can be geographically distributed to provide high availability and high performance by distributing content or services based, in some instances, on proximity to client devices 102A-102N. The closer a CDN server is to a client device 102A-102N, the faster the content can be delivered to the client device 102A-102N.

A media item can include an electronic file that can be executed or loaded using software, firmware or hardware configured to present the media item to a user. A media item 122 can include, and is not limited to, digital video, digital movies, digital photos, digital music, audio content, melodies, website content, social media updates, electronic books (ebooks), electronic magazines, digital newspapers, digital audio books, electronic journals, web blogs, real simple syndication (RSS) feeds, electronic comic books, software applications, etc. In some implementations, the media item 122 can be a live-stream media item. In some implementations, content sharing platform 120 can store the media items 122 using the data store 106, or can the media items (or and identifier of the media item) as electronic files in one or more formats using data store 106.

A video item is used as an example of a media item 122 throughout this disclosure. A video item is a set of sequential image frames representing a scene in motion. For example, a series of sequential image frames can be captured continuously or later reconstructed to produce animation. Video items can be presented in various formats including, but not limited to, analog, digital, two-dimensional and three-dimensional video. Further, video items can include movies, video clips or any set of animated images to be displayed in sequence. In addition, a video item (or media item) can be stored as a video file that includes a video component and an audio component. The video component can refer to video data in a video coding format or image coding format (e.g., H.264 (MPEG-4 AVC), H.264 MPEG-4 Part 2, Graphic Interchange Format (GIF), WebP, etc.). The audio component can refer to audio data in an audio coding format (e.g., advanced audio coding (AAC), MP3, etc.). It can be noted GIF can be saved as an image file (e.g., .gif file) or saved as a series of images into an animated GIF (e.g., GIF89a format). It can be noted that H.264 can be a video coding format that is a block-oriented motion-compensation-based video compression standard for recording, compression, or distribution of video content, for example.

In some implementations, the media item can be streamed, such as in a live-stream, to one or more of client devices 102A-102Z. It is be noted that “streamed” or “streaming” refers to a transmission or broadcast of content, such as a media item, where the received portions of the media item can be played back by a receiving device immediately upon receipt (within technological limitations) or while other portions of the media content are being delivered, and without the entire media item having been received by the receiving device. “Stream” can refer to content, such as a media item, that is streamed or streaming. A live-stream media item can refer to a live broadcast or transmission of a live event, where the media item is concurrently transmitted, at least in part, as the event occurs to a receiving device, and where the media item is not available in its entirety.

In some implementations, content sharing platform 120 can allow users to create, share, view or use playlists containing media items (e.g., playlist A-Z, containing media items 122). A playlist refers to a collection of media items that are configured to play one after another in a particular order without any user interaction. In some implementations, content sharing platform 120 can maintain the playlist on behalf of a user. In some implementations, the playlist feature of the content sharing platform 120 allows users to group their favorite media items together in a single location for playback. In some implementations, content sharing platform 120 can send a media item on a playlist to client device 102A-102N for playback or display. For example, media player 104A-104N can be used to play the media items on a playlist in the order in which the media items are listed on the playlist. In another example, a user can transition between media items on a playlist. In yet another example, a user can wait for the next media item on the playlist to play or can select a particular media item in the playlist for playback.

The content sharing platform 120 can include multiple channels (e.g., channels A through Z, of which only channel A is shown in FIG. 1) for providing media items from a common source or having a common topic, theme, or substance. Each channel can include one or more media items and can be managed by an owner (referred to as a “channel owner”), who is a user that can perform administrative actions on the channel. The administrative actions can include making media items available on the channel (e.g., choosing, uploading, and/or allowing presentation of the media items), enabling advertisements for the media items, enabling one or more membership tiers on the channel, etc. For example, a channel X (not shown) can include video media items Y and Z that were uploaded by the channel owner.

In some implementations, the channel owner can enable channel memberships that provide one or more membership tiers on a channel. Each membership tier can allow “members” to join the channel through monthly fees and receive privileges (e.g., members-only benefits) that can include access to exclusive content items (e.g., member-only media items, member-only posts, etc.), badges, emojis, access to live-streams, chats, etc. In some implementations, a particular channel can offer multiple membership tiers, where each level can include different privileges for a different monthly fee.

Content sharing platform 120 (and/or server machine 150 and/or client device 102A-102N) can include channel membership engine 152 that can generate content items for one or more channel owners of content sharing platform 120. Content items can include auto-generated content items, such as, for example, auto-generated media items (e.g., videos), auto-generated posts, etc. In some implementations, the generated content item(s) can be presented on media player 104A-104N (e.g., on the user interface associated with a channel of a channel owner) and/or provided to the channel owner using other means. In these implementations, the channel owner can have the option to request that the generated content items be posted on the channel or edit the generated content items prior to posting. It is noted that while the present application will discuss automatically generated posts and video, the system of the present disclosure can be used to generate any type of media items or channel related content (e.g., polls, quizzes, etc.).

In some implementations, the content items can include an auto-generated members-only post. The auto-generated post can include, for example, a launch post, a video upload post, a commemoration post, a milestone post, etc. A launch post can include a post indicating to viewers that the channel enabled channel memberships. A video related post can include any post that relates to a video, such as, for example, a post describing a recently uploaded video (e.g., a video summary). A commemoration post can include a post describing certain member-related commemorations. For example, a commemoration post can be auto-generated every predetermined time period (e.g., every month) and can list members with certain observances (e.g., annual anniversaries, biannual anniversaries, a certain number of months since joining the channel, new members, etc.). A milestone post can include a post describing certain channel-related milestones, such as the channel gaining a certain number of members (e.g., channel has 100 members, 500 members, etc.).

In some implementations, the content items can include an auto-generated members-only video. The auto-generated video can include, for example, a video summary, a behind the scenes video, a commemoration video, etc. A video summary can include a video with highlights from one or more other videos on the channel, such as from a recent live-stream. A behind the scenes video can include a video generated from unposted footage. For example, in certain instances, a channel owner can generate (e.g., record) content that is unposted, and generate and post a video from certain segments of the content. The behind-the-scenes video can include a certain portion (e.g., highlights) of the unused content. A commemoration video can include a video reflecting certain member-related commemorations, such as a member anniversary since joining the channel.

In some implementations, content items can be generated and/or automatically posted in response to a trigger event. The trigger event can include any satisfied criterion and/or action related to the channel owner, the channel, and/or one or more members. For example, the trigger event can include the channel owner launching memberships (or a new membership tier), the posting of a media item to the channel, a member-related commencement, a channel related milestone, a threshold criterion being satisfied (e.g., occurrence of a specific date, time, etc.), and so forth. In some implementations, trigger events can be enabled and/or disabled via, for example, media player 104A-104N. For example, the UI of media player 104A-104N can present one or more toggles or buttons corresponding to respective trigger events. This allows the channel owner to select which type of content items is automatically posted, which type of content items is to be auto-generated and presented to the channel owner for review, and which type of content items is not to be auto-generated. In some implementations, a set of trigger events for the channel can be generated and presented to the channel owner. The channel owner can then select a subset of the set of trigger events and data identifying the subset of trigger events can be stored for monitoring.

In some implementations, certain content items can be exclusive (e.g., for members only) for a certain time period. Upon expiration of the time period, the content items can be made available to all viewers (made public). For example, an auto-generated summary of a livestream can be made available to members for two days, then made available for all views upon the expiration of the two-day period. The time period can be determined, for each type of content item, by the content sharing platform 120 and/or set by, for example, the channel owner.

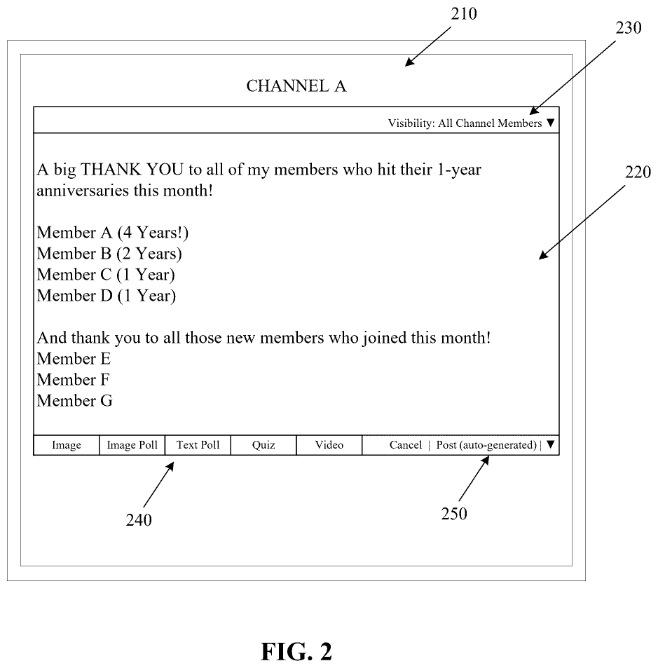

FIG. 2 is an example graphical user interface (GUI) showing an example auto-generated post, in accordance with implementations of the present disclosure. In particular, FIG. 2 shows GUI 210 which presents a channel owner's channel (e.g., channel A). Channel A includes post 220 generated by channel membership engine 152, which is a commemoration post thanking members with anniversaries (i.e., Members A-D) and thanking new members (i.e., Members E-G). The post is generated in a text field related to submitting posts to the channel A. Button 230 allows the channel owner to select (via a pulldown menu) which type of viewers can view the post. As shown, all channel members are selected to view post 220. In other examples, only members of a certain tier(s) can be selected to view post 220 (or any other content items), all viewers can be selected to view post 220, etc. Button 240 allows the channel owner to generate new posts, such as image posts, image polls, text polls, quizzes, videos, etc. Button 250 allows the channel member to submit auto-generated post 220 to channel 210. In some instances, the channel owner can manually edit post 220 prior to submitting the post to channel 210.

Returning to FIG. 1, in some implementations, the content items can be generated using data obtained from LLM 160. An LLM is a type of artificial intelligence (e.g., machine learning) model designed to understand and generate human-like text. In particular, LLM 160 can perform natural language processing tasks such as language translation, text summarization, question answering, etc. LLM 160 can be built on deep learning architectures, such as transformer models. In some implementations, LLM 160 can be generated through supervised learning, during which LLM 160 is trained on large datasets of text. The text can be gathered from various sources, such as books, articles, websites, content sharing platform contents (e.g., media item titles, comments, media item descriptions, etc.), and so forth.

In some implementations, a text dataset can be used to pre-train LLM 160 on a language modeling task where LLM 160 learns to predict the next word in a sequence of text given the previous words. This pre-training phase can be used to develop, for LLM 160, a deep understanding of language patterns and semantics. After pre-training, LLM 160 can be fine-tuned on specific tasks to specialize its capabilities. During fine-tuning, LLM 160 can be exposed to examples of the target task, such as text classification or language translation, corresponding labels or target outputs, etc. In some implementations, LLM 160 can adjust one or more parameters to minimize the difference between predictions and true outputs. The adjusting can be performed using iterative optimization techniques, such as, for example, gradient descent. The adjusting process can enable LLM 160 to adapt pre-learned knowledge to the nuances of the target task, making it more effective in real-world applications. In some implementations, LLM 160 can be used to generate one or more content item. This will be described in detail below.

In some implementations, LLM 160 can be pre-trained and/or fine-tuned on data (e.g., posts, comments, replies, media items, channel names, channel descriptions, channel metadata, most replayed data, etc.) from many different users, such as, for example, channel owners, viewers, members, etc. A post can be content that is shared with viewers (e.g., members), such as, for example, text (e.g., a story), an image, a video, a poll, a quiz, etc. A comment can refer to a response to the post, while a reply can refer to a response to a comment. The channel name can refer to the name given to the channel by, for example, the channel owner. The channel description can refer to an “about” section that describes the channel owner, the type of content the channel offers, why viewers should consume media items from the channel, the purpose of the channel, etc. The channel metadata can refer to descriptive data related to the channel. In some implementations, the channel metadata can be stored in a hierarchical structure. For example, a parent node can describe an overall theme of the subject matter offered by the channel (e.g., sports, gaming, arts, music, science, etc.), and one or more child nodes can describe a subdivision of the theme. For example, if the theme is sports, a first child node can describe the type of sport (e.g., hockey, soccer, paintball, etc.), a second child node can describe categories related to the specific types of sports (e.g., analysis, clips, etc.). The most replayed data can refer to a video feature that shows the most replayed parts of a video. For example, the most replayed feature can include a graph that moves up and down along a video's timeline, indicating the most and least popular part so the content. The most replayed data can be used to, for example, teach LLM 160 which part of videos viewers typically prefer, which can aid LLM 160 in generating summaries of media items, behind-the-scenes videos, etc. The channel metadata can be auto-generated, user generated, or any combination thereof.

LLM 160 can thus serve as an LLM model fine-tuned to understand how content creators generate content items for their channel members. In some implementations, multiple LLMs can be trained based on groups of users having certain characteristics or of a certain location. For example, each LLM 160 can be pre-trained and/or fine-tuned based on a set of regional users (e.g., country, state, providence, etc.), a set of users with specific characteristics (e.g., age brackets, gender, race, language, interests, etc.), a set of interests (gaming, sports, arts, music, etc.), and so forth. In some implementations, LLM 160 can be periodically retrained (e.g., refined) using new data, such as, for example, posts, channel owner edits to auto-generated posts, comments, media items, etc.

In some implementations, LLM 160 can be trained using one or more audio related features (e.g., audio transcription data). Audio transcription data can include a transcription of the audio data from a segment of a media item (e.g., from a video) or from the entirety of the media item. In some implementations, transcription engine 154 can generate the audio transcription data using a text extractor system (e.g., software, an algorithm, etc.). For example, transcription engine 154 can convert audio data corresponding to a media item (or corresponding to one or more segments of the media item) into text data. Examples of the text extractor system can include a text-embedding model (e.g., the universal sentence embedding model), a speech recognition model, a speech-to-text model, etc. In some implementations, the audio transcription data can be generated by user input. For example, a user (e.g., a channel owner) can generate a transcript of the audio corresponding to one or more segments of a media item and/or to one or more media items. The transcript can be included, for example, as metadata related to the media item. In some implementations, the audio transcription data can be generated using an optical character recognition (OCR) system. An OCR system can include a software tool that converts visual data (e.g., images, frames, etc.) into editable and searchable text. In one example, an OCR system can generate text data from closed captions or subtitles associated with a media item 122 (e.g., if such closed captions or subtitles associated with the media item 122 are not otherwise available).

In some implementations, in order to generate the content items, channel membership engine 152 can instruct LLM 160 to perform one or more tasks. A task can refer to the type of data or analysis desired from LLM 160. The tasks can include, for example, determining the content of a channel, generating one or more content items, etc.

The output format can reflect how the LLM 160 is to provide the data it was tasked to obtain. In some implementations, the output format can instruct LLM 160 of the type of content to be included in the output data (e.g., a commemoration post for anniversaries and new member and a corresponding commemoration video), which file format to use when providing the output data (e.g., present the data in JavaScript Object Notation (JSON) format, YAML Ain′t Markup Language (YMAL), MP4, MPEG4, etc.).

Channel membership engine 152 can then obtain, as output from LLM 160, data reflecting one or more content items, etc. Channel membership engine 152 can then supply the content item(s) for review by the channel owner, or to automatic submission by, for example, content sharing platform 120. This allows the channel owner to auto-generate content items.

In some implementations, other AI models can be used in place or in addition to LLM 160, such as deep networks. An example of a deep network is a neural network with one or more hidden layers, and such an AI model can be trained by, for example, adjusting weights of a neural network in accordance with a backpropagation learning algorithm or the like. In other or similar implementations, the AI model can be created by finding patterns in training data, identifying clusters of data that correspond to the identified patterns, and providing the AI models that capture these patterns. Some AI models can use one or more of support vector machine (SVM), Radial Basis Function (RBF), clustering, supervised machine learning, semi-supervised machine learning, unsupervised machine learning, k-nearest neighbor algorithm (k-NN), linear regression, multi-linear regression, non-linear regression, random forest, gradient-boosted trees, neural network (e.g., artificial neural network), etc.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

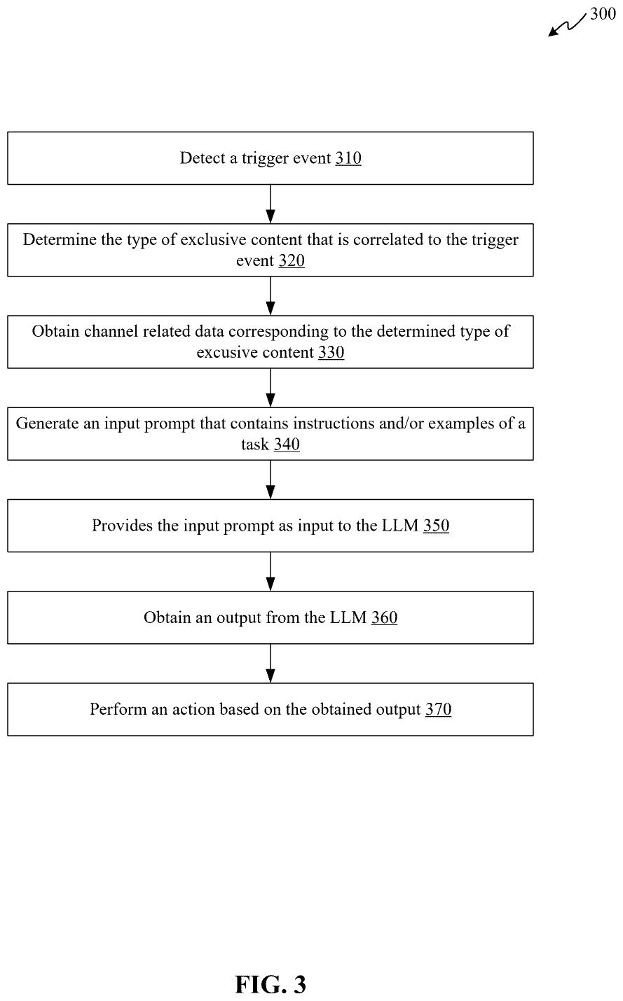

FIG. 3 depicts a flow diagram of an example method 300 for generating membership related content, in accordance with implementations of the present disclosure. Method 300 can be performed by processing logic that can include hardware (circuitry, dedicated logic, etc.), software (e.g., instructions run on a processing device), or a combination thereof. In one implementation, some or all of the operations of method 300 can be performed by one or more components of system 100 of FIG. 1. In some implementations, some or all of the operations of method 300 can be performed by channel membership engine 152, as described above.

For simplicity of explanation, method 300, as well as any other method of this disclosure, is depicted and described as a series of acts. However, acts in accordance with this disclosure can occur in various orders and/or concurrently, and with other acts not presented and described herein. Furthermore, not all illustrated acts may be required to implement method 300 in accordance with the disclosed subject matter. In addition, those skilled in the art will understand and appreciate that method 300 could alternatively be represented as a series of interrelated states via a state diagram or events. Additionally, it should be appreciated that method 300 disclosed in this specification is capable of being stored on an article of manufacture (e.g., a computer program accessible from any computer-readable device or storage media) to facilitate transporting and transferring such method to computing devices. The term “article of manufacture,” as used herein, is intended to encompass a computer program accessible from any computer-readable device or storage media.

At operation 310, processing logic detects a trigger event. The trigger event can include a satisfied criterion and/or action performed that is related to the channel owner, the channel, and/or one or more member. In some implementations, the trigger event can include the channel owner launching memberships (or a new membership tier) on their channel, the channel owner posting a media item on their channel, a threshold criterion being satisfied (e.g., the occurrence of a specific date or time, a number of new members exceeding a predetermined value, etc.), a button selected by the channel owner (e.g., a button to auto-generate content items, such as, for example, a behind the scenes video), etc. In some implementations, the processing logic can monitor actions related to at least one of the channel, the channel owner and/or one or more members of the channel. If the processing logic determines that at least one of the monitored actions corresponds to a certain trigger event from a subset of trigger events, the processing logic can determine that a trigger event has been detected.

At operation 320, processing logic determines the type of content items that is correlated to the trigger event. For example, the trigger event of the channel owner launching memberships can be correlated to a launch post, the trigger event of the occurrence of a certain time on a certain date can correlated to a commemoration post and/or video, the trigger event of the number of members exceeding a certain threshold value can be correlated to a milestone post, the trigger event of the upload of a video can be correlate to a video-related post (e.g., a video summary post), etc.

At operation 330, processing logic obtains channel related data corresponding to the type of the content items determined in operation 320. The channel related data can include media item titles, channel metadata, one or more audio related features (e.g., audio transcription data), member-related data (e.g., number of members, names of certain members, correlated anniversary data, etc.), one or more media items, media item related data (e.g., most replayed data, viewer comments, etc.), popularity data (e.g., number of likes, like to dislike ratios, etc.), and so forth.

At operation 340, processing logic generates an input prompt that contains instructions and/or examples of a task. The input prompt can serve to guide the output of LLM 160. The processing logic can generate the input prompt based on the determined type of content items that is to be generated. In some implementations, the contents of the input prompt can be retrieved from, for example, a data structure.

In some implementations, the input prompt can include content instructions. Content instructions can be used to inform an LLM (e.g., LLM 160) about the type of conversation LLM 160 is engaging in and/or the function LLM 160 is to perform. The context instructions can be used to aid LLM 160 in avoiding lengthy replies, consistently generating readable text, expediting operations, etc. In an illustrative example, context instructions can include the following prompt:
Channel memberships are a way for viewers to directly support a channel through recurring monthly payments. Members get access to exclusive content and perks that the channel owner can define when setting up the channel memberships on their channel.
Channel owners typically post exclusive content for the member, such as posts and videos.

In some implementations, the input prompt can include task instructions. Task instructions can be used to identify the type of data or analysis desired from LLM 160. In an illustrative example, task instructions can include the following prompt:
Your task is to generate a post describing a video uploaded to the channel. The post should be a summary of the video for the members. A link to the video can be found using this hyperlink <LINK>.
In another illustrative example, task instructions can include the following prompt: Your task is to generate a post thanking each member with an anniversary this month. The anniversary is related to any number of years that the member has been with the channel. Please use the following data <channel related data> to generate the post. Please also include a thank you to each new member that joined the channel this month.
In another illustrative example, task instructions can include the following prompt: We have achieved 1000 members on this channel. Your task is to generate a post thanking all of the members for his accomplishment.
In another illustrative example, task instructions can include the following prompt: Your task is to generate a video that summarizes the following live-streamed video <LINK>. Please limit the video to approximately 30 minutes and include mostly highlights and interesting content from the live-streamed video.
In another illustrative example, task instructions can include the following prompt: Your task is to generate a video that includes behind-the-scenes footage from this raw video <LINK 1>. Please review the raw video and the posted video found here <LINK 2>. Please limit the video to approximately 10 minutes and include mostly footage that did not appear in the posted video. Please include interesting content from the raw video.
In another illustrative example, task instructions can include the following prompt: Your task is to generate a video thanking each member with an anniversary this month. The anniversary is related to any number of years that the member has been with the channel. Please use the following data <channel related data> to generate the post. Please also include a thank you to each new member that joined the channel this month. Please limit the video to approximately 2 minutes.

In some implementations, the input prompt can include one or more examples. The examples can provide additional context to LLM 160, such as, for example, how LLM 160 should answer. In particular, the examples can illustrate to LLM 160 the type of data desired, the type of format desired, how to format a post with a link to a video, how to tag members, example input data and correlating output data, etc.

In some implementations, the input prompt can include distinction data. The distinction data can be used to instruct LLM 160 of non-desired answers.

In some implementations, the input prompt can include the channel related data obtain at operation 330.

At operation 350, processing logic provides the input prompt as input to LLM 160. For example, processing logic 350 provides the input prompt including the content described above and instructions to the LLM to perform the requested task.

At operation 360, processing logic obtains an output from LLM 160. The output can reflect the results generated by LLM 160 from performing the requested task. In some implementations, the output can be in the format that LLM 160 was requested to use. In some implementations, the output can include specific content for the channel members of the channel. One or more or operations 320-360 can be automatically performed in response to the trigger event.

At operation 370, processing logic performs an action using the obtained output. In some implementations, such as those where the channel owner selected the option to review auto-generated content items, the processing logic can pre-fill, based on the obtained output, a post field (e.g., a text field related to generating a post) related to generating a post for members and/or provide a video to the upload and/or edit GUI of the channel. The channel owner can then edit the post or video (or any other generated exclusive content items) and/or submit the content items to the channel. In some implementations, such as those the channel owner selected the option to automatically post auto-generated content items, the processing logic can submit the post and/or upload the video to the channel.

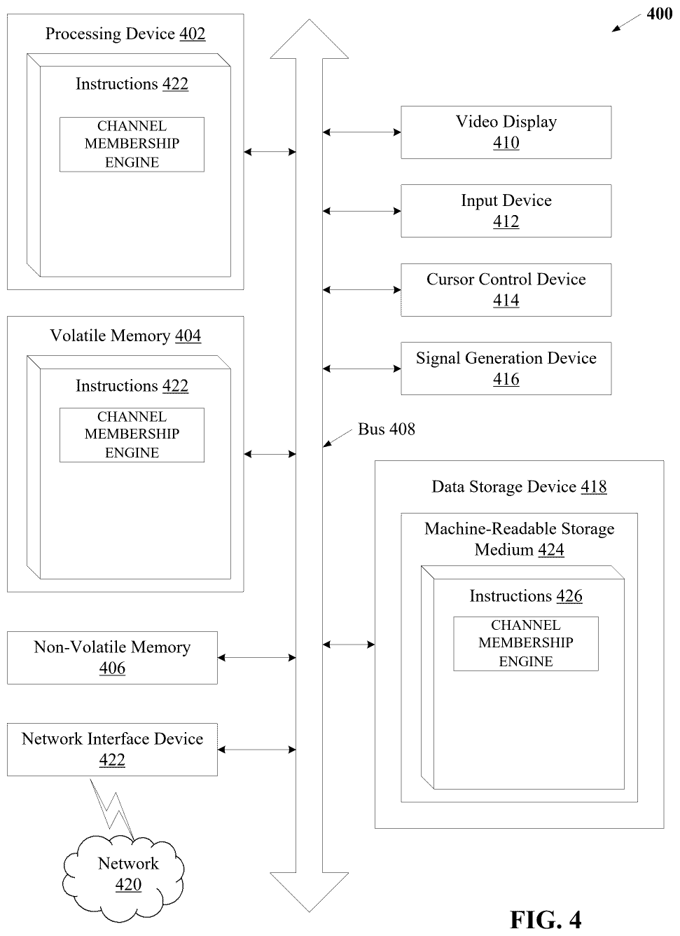

FIG. 4 depicts a block diagram of a computer system operating in accordance with one or more aspects of the present disclosure. In certain implementations, computer system 400 can be connected (e.g., via a network, such as a Local Area Network (LAN), an intranet, an extranet, or the Internet) to other computer systems. Computer system 400 can operate in the capacity of a client device. Computer system 400 can operate in the capacity of a server or a client computer in a client-server environment. Computer system 400 can be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 400 can include a processing device 402, a volatile memory 404 (e.g., random access memory (RAM)), a non-volatile memory 406 (e.g., read-only memory (ROM) or electrically erasable programmable ROM (EEPROM)), and a data storage device 418, which can communicate with each other via a bus 408.

Processing device 402 can be provided by one or more processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 400 can further include a network interface device 422. Computer system 400 also can include a video display unit 410 (e.g., an LCD), an input device 412 (e.g., a keyboard, an alphanumeric keyboard, a motion sensing input device, touch screen), a cursor control device 414 (e.g., a mouse), and a signal generation device 416.

Data storage device 418 can include a non-transitory machine-readable storage medium 424 on which can store instructions 426 encoding any one or more of the methods or functions described herein, including instructions encoding components of client device of FIG. 1 for implementing method 400.

Instructions 426 can also reside, completely or partially, within volatile memory 404 and/or within processing device 402 during execution thereof by computer system 400, hence, volatile memory 404 and processing device 402 can also constitute machine-readable storage media.

While machine-readable storage medium 424 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein can be implemented by discrete hardware components or can be integrated in the functionality of other hardware components such as ASICS, FPGAs, DSPs or similar devices. In addition, the methods, components, and features can be implemented by firmware modules or functional circuitry within hardware devices. Further, the methods, components, and features can be implemented in any combination of hardware devices and computer program components, or in computer programs.

Unless specifically stated otherwise, terms such as “receiving,” “determining,” “sending,” “displaying,” “identifying,” “selecting,” “excluding,” “creating,” “adding,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and cannot have an ordinal meaning according to their numerical designation.

Examples described herein also relate to an apparatus for performing the methods described herein. This apparatus can be specially constructed for performing the methods described herein, or it can comprise a general-purpose computer system selectively programmed by a computer program stored in the computer system. Such a computer program can be stored in a computer-readable tangible storage medium.

The methods and illustrative examples described herein are not inherently related to any particular computer or other apparatus. Various general-purpose systems can be used in accordance with the teachings described herein, or it can prove convenient to construct more specialized apparatus to perform method 400 and/or each of its individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

What is claimed is:

1. A method comprising:
detecting, by a processing device of a content sharing platform, a trigger event associated with a channel of the content sharing platform;
in response to the trigger event, automatically generating content for a plurality of channel members associated with the channel, wherein automatically generating the content for the plurality of channel members comprises:
determining a type of content associated with the trigger event;
generating a prompt based on the trigger event and the type of content; and
determining, using an artificial intelligence (AI) model and the generated prompt, the content for the plurality of channel members associated with the channel; and
performing an operation using the generated content.

2. The method of claim 1, wherein detecting the trigger event associated with the channel of the content sharing platform further comprises:
monitoring a plurality of actions related to the channel, a channel owner of the channel and one or more members of the channel; and
determining that at least one of the plurality of actions corresponds to the trigger event of a subset of a plurality of trigger events.

3. The method of claim 2, further comprises:
generating the plurality of trigger events for the channel;
presenting the plurality of trigger events to the channel owner;
receiving a selection of the subset of the plurality of trigger events by the channel owner; and
storing data identifying the subset of the plurality of trigger events in association with the channel.

4. The method of claim 2, wherein the plurality of actions comprises one or more of launching of a channel membership, addition of one or more new membership tiers to the channel, posting of a media item on the channel by the channel owner, a request of the channel owner to generate a content item for the channel, or addition of one or more new members to the channel.

5. The method of claim 1, wherein generating the prompt further comprises:
obtaining channel data related to the type of content associated with the trigger event; and
generating one or more instructions to perform a task pertaining to the trigger event and the type of content associated with the trigger event, wherein the generated prompt comprises the channel data and the one or more instructions.

6. The method of claim 5, wherein the channel data comprises one or more of titles of media items of the channel, channel metadata, audio transcription data associated with the media items of the channel, a number of members of the channel, memberships initiation dates of members of the channel, popularity of the media items of the channel, or viewer comments for the media items of the channel.

7. The method of claim 1, wherein:
the generated content comprises one or more of a post for the channel or a video clip for the channel;
the post comprises a summary of a recently uploaded video, a commemoration post marking an anniversary of a member joining the channel or an acknowledgment of a new member joining the channel, a milestone post highlighting channel-related achievements, or a launch post announcing availability of channel memberships to channel users; and
the video comprises a summary video with highlights from one or more media items of the channel, a video generated from unposted footage, or a commemoration video reflecting member related observances.

8. The method of claim 1, wherein the operation comprises at least one of posting the generated content on the channel, providing the generated content to the channel owner for review, or pre-filling a text field related to submitting the generated content to the channel.

9. The method of claim 1, wherein the AI model is trained using data associated with a set of most replayed segments from a plurality of media items of the channel.

10. A system comprising:
a memory; and
a processing device, coupled to the memory, the processing device to perform operations comprising:
detecting, a trigger event associated with a channel of a content sharing platform;
in response to the trigger event, automatically generating content for a plurality of channel members associated with the channel, wherein automatically generating the content for the plurality of channel members comprises:
determining a type of content associated with the trigger event;
generating a prompt based on the trigger event and the type of content; and
determining, using an artificial intelligence (AI) model and the generated prompt, the content for the plurality of channel members associated with the channel; and
performing an operation using the generated content.

11. The system of claim 10, wherein detecting the trigger event associated with the channel of the content sharing platform further comprises performing operations of:
monitoring a plurality of actions related to the channel, a channel owner of the channel and one or more members of the channel; and
determining that at least one of the plurality of actions corresponds to the trigger event of a subset of a plurality of trigger events.

12. The system of claim 11, wherein the operations further comprise:
generating the plurality of trigger events for the channel;
presenting the plurality of trigger events to the channel owner;
receiving a selection of the subset of the plurality of trigger events by the channel owner; and
storing data identifying the subset of the plurality of trigger events in association with the channel.

13. The system of claim 11, wherein the plurality of actions comprises one or more of launching of a channel membership, addition of one or more new membership tiers to the channel, posting of a media item on the channel by the channel owner, a request of the channel owner to generate a content item for the channel, or addition of one or more new members to the channel.

14. The system of claim 10, wherein generating the prompt further comprises:
obtaining channel data related to the type of content associated with the trigger event; and
generating one or more instructions to perform a task pertaining to the trigger event and the type of content associated with the trigger event, wherein the generated prompt comprises the channel data and the one or more instructions.

15. The system of claim 14, wherein the channel data comprises one or more of titles of media items of the channel, channel metadata, audio transcription data associated with the media items of the channel, a number of members of the channel, memberships initiation dates of members of the channel, popularity of the media items of the channel, or viewer comments for the media items of the channel.

16. The system of claim 10, wherein:
the generated content comprises one or more of a post for the channel or a video clip for the channel;
the post comprises a summary of a recently uploaded video, a commemoration post marking an anniversary of a member joining the channel or an acknowledgment of a new member joining the channel, a milestone post highlighting channel-related achievements, or a launch post announcing availability of channel memberships to channel users; and
the video comprises a summary video with highlights from one or more media items of the channel, a video generated from unposted footage, or a commemoration video reflecting member related observances.

17. The system of claim 10, wherein the operation comprises at least one of posting the generated content on the channel, providing the generated content to the channel owner for review, or pre-filling a text field related to submitting the generated content to the channel.

18. The system of claim 10, wherein the AI model is trained using data associated with a set of most replayed segments from a plurality of media items of the channel.

19. A non-transitory computer-readable medium comprising instructions that, responsive to execution by a processing device, cause the processing device to perform operations comprising:
detecting a trigger event associated with a channel of a content sharing platform;
in response to the trigger event, automatically generating content for a plurality of channel members associated with the channel, wherein automatically generating the content for the plurality of channel members comprises:
determining a type of content associated with the trigger event;
generating a prompt based on the trigger event and the type of content; and
determining, using an artificial intelligence (AI) model and the generated prompt, the content for the plurality of channel members associated with the channel; and
performing an operation using the generated content.

20. The non-transitory computer readable storage medium of claim 19, wherein detecting the trigger event associated with the channel of the content sharing platform further comprises performing operations of:
monitoring a plurality of actions related to the channel, a channel owner of the channel and one or more members of the channel; and
determining that at least one of the plurality of actions corresponds to the trigger event of a subset of a plurality of trigger events.
